(19) United States
(12) Patent Application Publication
(10) Pub. No.: US 2007/0014825 A1
(43) Pub. Date: Jan. 18, 2007

(54) Ant bait attractive to many species of ants and useful in their rapid control

(76) Inventor: James Hua-Hin Chan, Martinez, CA (US)

Correspondence Address: HARRY A. PACINI, 410 HIDDEN MEADOWS CT., RENO, NV, 89502-8764, US

(21) Appl. No.: 11/178,520

(22) Filed: Jul. 12, 2005

(51) Int. Cl. A01N 25/08

(52) U.S. Cl. 424/410

(57) ABSTRACT

An attractant bait composition and method for the control of many species of ants which includes a food base, attractants, sweeteners, carriers, dispersants, surfactants, fragrances, preservatives and one or more toxicants; wherein the method of application is of an ant bait composition having delayed ant toxic action comprising an ant attractant bait, containing a toxic effective amount of an ant effective toxicant, and in a delayed action formulation free of ant repellency characteristics. Further, considerations in the design selection of a bait material is the consistency of the bait, taste of the bait, speed of action of the toxicant, type of toxicant and odor as perceived by the ants.

### BACKGROUND OF THE INVENTION

Ants have been a problem to man for thousands of years. Various means have been used over the years to control them. Many of these are described in the US patent literature and art. These have been effective to a greater or lesser degree but all the different ways have problems in degree of control or length of time in their effectiveness. Insecticidal sprays are generally of less utility when compared with an effective bait. Insecticidal sprays require much more toxicant than is usually needed for a properly designed bait. Sprays too only give partial control of the ants in their nest and they quickly recover. Baits for many ant species is the best tactic in that the nests are completely destroyed. This gives a more permanent solution to the particular ant problem. A properly designed bait will use low levels of toxicant and thus have low levels of toxicity to those living in the area and to their pets or animals or birds. When residual sprays are used in the area, ants may die before they take treated baits back to the nest or warn the remainder of the nest of the potential toxicity of the bait. Thus sprays should not also be used when baits are set for control. Also this points out the importance of having the proper level of toxicant in the bait so that premature death of the carrier ant does not occur. Baits must not show toxic effects until sometime after the carrier ant returns to the ant colony. But the total toxic effect should occur within a few hours after the carrier ant arrives at the nest. Slow acting toxins often allow the remaining part of the colony to move from the area and form new colonies.

Another important aspect of bait design is to have a bait that is readily located by the ant and then taken quickly back to the offending nest to the queen ant and the rest of the colony. Here it is important that the bait is attractive to the offending ants in the foraging area. They must readily accept it in preference to other food available in the area. It is usually important that the bait not be placed on the offending ant colony because this puts the ants on the alert to the potential of tainted food. Still at the same time the bait must be placed in the area where the ants are actively foraging for food. It is also important that the size and texture of the bait is such that it is readily accepted and taken back to the nest with only minor consumption by the foraging ant. A human analogy is that it must act like desert and taken home for the rest of the family to enjoy. This further points out the importance of texture, attractiveness, taste and smell in the design of an effective ant bait. Here the bait must have the proper smell appeal to the ant and at the same time not have an objectionable odor to people living in the area. Here the proper use of various fragrances is important and will be discussed later. Fragrances can be both attractive and repulsive to ants. Therefore odor characteristics of the bait are very important.

Baits for sugar loving ants require that sweeteners or taste enhancers be included in the design of ant baits. The proper choice of a sweetener is very important in the design of an ant bait. Sweetness or taste to ants is not the same as that perceived by people or other animals. For outdoor treatment the bait should not also be attractive to animals and birds in the area. Color is also important in this regard. Certain bright contrasting colors are often attractive to birds and animals.

Each of the above important characteristics elicited above will be further described relating to the current invention.

### DESCRIPTION OF THE PRIOR ART

There is a considerable amount of prior art that has developed over many years in the field of insect bait design and ant bait in particular. However, many of these approaches are overly simplistic in their teaching and design. There are many characteristics necessary for an effective ant bait as described above and will be further described in the body and claims of this invention. Certain characteristics are obvious in the design of an effective ant bait. The prior art teaches that there must be an attractant, a carrier, and a toxicant. This art is exemplified in the currently available commercial ant baits available today. These are targeted to only certain types of ant pest or species—such as sweet loving or oil loving ants. There are approximately 15,000 species of ants (and many sub families) with their own special characteristics. The following is typical of the various types of ant pests found throughout the world:

Fire Ants:

| | |
|---|---|
| Solenopsis xyloni | southern fire ant |
| Soleneopsis geminata | tropical fire ant |
| Soleneopsis invicta | red imported fire ant |
| Soleneopsis qeminata | tropical fire ant |
| Soleneopsis richteri | black fire ant |
| Soleneopsis saevissima | fire ant |
| Soleneopsis molesta | thief ant |
| Waswannia auropuncata | little fire ant |

Carpenter Ants: (Genus Componatus)

| | |
|---|---|
| Componotus Floridans | Florida carpenter ant |
| Componotus Floridans | bull ant |
| Componotus Pennsylvanicus | black carpenter ant |
| Componotus herculanus | black ant, carpenter ant |
| Camponotus japonicus | Kuro-oo-ari (Japanese name) |
| Camponatus planatus | compact carpenter ant |
| Camponatus maculatus | (widely reported in Africa} |

Argentine Ants:

| | |
|---|---|
| Iridomyrex humilis | Argentine ant |
| Linepithema humile | Argentine ant |

Pharaoh Ants:

| | |
|---|---|
| Monomarium pharonis | pharaoh ant |
| Monomarium minimum | little black ant |

Harvester Ants:

| | |
|---|---|
| Pogonomyrmex badius | Florida harvester ant or |
| | Bull ants |
| Pogonomyrmex barbadus | Red harvester ant |
| Pogonomyrmex deseretorum | Desert harvester ant |
| Pogonomyrmex occidentalis | Western harvester ant |
| Laser niger | Black ant (England) |
| Laser niger | Cornfield Ant (US) |
| Polyergus rufescens | Slave market ant |
| Polyergus rufescens | Red Amazon ant |
| Atta texana | Tes leaf cutting ant |
| Lasius fuliginosa | European jet ant |
| Formica sanguinea | Red blood ant |
| Formica polytena | Flying ant |
| Tetramorium caespitum | Pavement ant |
| Formica rufa | Red ant |
| Myrmecocysrus sp. | Desert ant |
| Eciton hamatum | Legionary ants |
| Campamponutus consobrinus | Sugar ant |
| Tapinoma sessile | Odorous house ant |
| Tapinoma sessile | Grease ant |
| Technomyrmex albipes | White-footed ant |
| Crematogaster sp. | Acrobat ant |
| Crematogaster lineolata | Acrobat ant |
| Acanthomyops sp. | Citronella Ant |
| Prenolepis impairs | False honey ant |
| Myrmecolystus melliger | Honey ant (Southwest US) |
| Paratrechina longicorus | Crazy ant |
| Iridomyrmex prunus | Lawn ant |
| Oecophylla smaragdina | Red tree ant |

Many ant species pose a significant threat to man and his environment. In agriculture ants can attack crops and food stuffs and can render fields and pastures unusable. Fire ants and carpenter ants are good examples of this. In addition the sting of the fire ant is very painful to man and animals. Pharaoh ants are a plague world wide as household pests. They are carriers of pathogenic fungi and bacteria. Ants have been known to short circuit telephone and electricity lines. They are known to make nests in electronic equipment and cause equipment failure.

The typical commercial bait for ant control is composed of a carrier plus an attractant or food such as vegetable oil or soybean oil or a sugar as the attractant in the bait plus a toxicant of some kind. Improper choice of vegetable oil or sugar is actually repulsive to some ants to baits. Also oils become rancid on storage and repellent to many ants. Similarly many toxicants are repulsive to ants. With the exception of the present invention ant baits do a poor job in controlling a wide variety of ants. In general they lack shelf or field stability and most preservatives are actually repellant at the usual use concentrations.

U.S. Pat. No. 5,939,061 to Vail, et. al. represent the current art for a method of attracting a variety of pest arthropod species including ants. The method suffers from the fact that it is not a method of killing ants and their colonies. Ants are attracted to the bait but also need to carry the bait to the remainder of the colony where it can kill the total colony and thus control that particular ant problem.

### DESCRIPTION OF THE INVENTION

An ant bait consists of an active toxicant or insect control chemical mixed with an attractant or food. The ant bait can be a liquid, solid or gel. In case of a solid ant bait, the active toxicant and attractant is coated onto a carrier particle for the ant to carry the bait back to the nest.

In order for an ant bait of the current invention to provide effective control of ants, the following ingredients are necessary:

Active Toxicant

The active toxicant should show little or no repulsion to ants. It can be a solid (also a water soluble solid) or a liquid.

Speed of kill of the active toxicant should be moderate with approximately 2-4 hours (<0.5 hour is too fast, >24 hours is too slow). This moderate speed of kill of approximately 2-4 hours, provide the most effective or efficient kill of the ants, their entire nest and the queen. The differences in the speed of kill of ants by the insecticides are as follows:

A moderate speed of kill allows time (or distance) for the ants to carry the bait back to the nest, allowing the ant to feed the ant colony and the queen for a complete kill of the entire nest (see Table 1 and Fragrance section below).

A fast speed of kill (<0.5 hour) causes the ants to die before they have sufficient time to reach the nest. The ant colony and queen will not be killed, allowing the nest to survive.

A slow speed of kill (>24 hours) causes the ants in the nest to realize that there is a problem with the food or attractant. The ant colony and queen will immediately leave the nest, allowing the ant colony and queen to survive.

TABLE 1
Distance Traveled by Ant after Bait Ingestion Versus Amount of Ants
Killed - acephate is the toxicant

| | | Time of | | Time Ant | |
|---|---|---|---|---|---|
| | Level of | Ingestion | | Killed after | |
| Type of | toxicant | of Bait by | Distance | Bait | Nest |
| Ant | in Bait | Ant | Traveled | Ingestion | Killed |
| Carpenter | 1.2% | ˜20 | 1.5-2 feet | ˜22-23 | No |
| Ant | | minutes | | minutes | |
| Carpenter | 0.2% | ˜20 | 20-30 feet | Not observed | Yes |
| Ant | | minutes | (disappeared) | (disappeared | (Entire |
| | | | | after 35-40 | Nest |
| | | | | minutes) | Killed) |

Instead of a killing toxicant (0.5-12 hours for kill), an Insect Growth Regulator (IGR) is some times used in the ant bait, requiring 2-3 months before a decrease of ants in the colony is observed. This slow action of an IGR is due to deformation of eggs and newly hatched ants in the ant colony, not the current ants that living in the nest. This slow action of the IGR baits allows the existing colony of ants to infest the surroundings areas for at least two months before there is a decrease in activity.

Active toxicant (such as phosphate insecticides) decomposes (hydrolyzes) at a relatively fast rate resulting in the following:

Ants are slow to build up resistance to a phosphate toxicant. Ants and other insects are able to build up resistance when exposed over long periods of time to an active toxicant that is relatively stable.

The active phosphate toxicant, in dead ants or from the ant bait, decomposes or hydrolyzes in the environment to form phosphates that become nutrients for plants and trees.

The use of active toxicants containing chlorine, as well as toxicants that have high mammalian toxicity, in baits should be avoided. These active chlorinated insecticides used in ant baits, decompose or hydrolyze in the environment to form hydrogen chloride, or other chlorides that may be environmentally damaging. High mammalian toxic insecticides should not be used near human habitation, plantations and waterways. The use of large quantities of ant bait containing these chlorinated or toxic insecticides should therefore be avoided.

An effective ant bait can control ant infestations with the active toxicant level used at concentration levels of grams/acre. In the case of drench treatments, the active insecticide level used is at least hundreds of times higher at concentration levels of lbs/acre. Drench treatments require very high active insecticide levels that are not only wasteful and expensive, but are also hazardous and toxic to the environment.

The following are organophosphates which can be used as toxicants in ant baits at the proper low use level: acephate, azinphos-methyl, chlorpyrifos, diazinone, malathione, phosmet, prothiophos, pyririphos-methyl, and many others. Also the synthetic pyrethroids may be used as toxicants in ant baits at the proper use level: cyfluthrin, deltamethrin, permethrin, and esphenvalerate. Other toxicants would include: methomyl, carbaryl, and imidacloprid, and the like. Acephate is the most preferred toxicant.

Surfactant

Impregnation of the active insecticide in a water and or water soluble solid surfactant effectively extends the time of insect kill by slower release of the active insecticide in the ant after the ant has ingested the bait. This allows greater time for the ant to bring the bait back to the nest, feed the ants in the entire colony, resulting in effective kill of the entire nest.

The solid surfactant will mask the strong odor or repulsiveness of the active insecticide and allow maximum acceptance of the ant bait.

In case solid surfactants are unavailable, impregnation of the odorous active insecticide with small amounts of solids or oils of greasy animal and/or vegetable oils (including margarine, butter, peanut butter, cheese, bacon fat) are effective methods to impregnate the active insecticide.

Attractant

Different species of ants prefer different types of foods. They can be classified as follows:

Sweetner (sucrose and fructose), syrup, honey loving ants.

Oil (peanut, corn, sesame, soybean, palm and other vegetable oils, and animal fats) loving ants.

Protein (animal and vegetable protein as found in cat and dog foods) loving ants.

Chitin (shrimp and other shell crustacean) loving ants.

Milk (milk, evaporated, condensed milk, powdered milk products) loving ants.

In general, an ant bait should be tested for acceptance for a particular species of ant with the various above attractants before it is produced on a large scale for any type of ant eradication program.

Comparison tests or studies with any combination of the above attractants should be compared against a standard ant bait to determine if attractant combinations provide added synergies.

A general or universal ant bait is formulated by using various amounts of the attractants listed above.

Carrier

In a solid ant bait, a carrier (such as ground up bread crumbs, corn cereal or other types of grain) is used for impregnating or coating the intimate active toxicant and attractant mixture. The carrier provides a means to grind up the ant bait to an optimum particle size so that the ant can easily bring the bait back to the nest.

For liquid ant bait, an absorbent material such as a sponge, cotton ball, cotton swab, absorbent paper tissue, or any absorbent wick or material will be acceptable.

Gels or jelly ant baits, because they can be readily removed in any size by ants chewing on it, they are ideal for ants to break up and bring back to the nest.

Antioxidants

Antioxidants are necessary to extend shelf life of the packaged ant bait. They also prevent rancidity due to oxidation of the attractant in the ant bait when it is applied in the garden, field or open environment due to rain and moisture.

Most antioxidants such as butylated hydroxy anisole and butylated hydroxy toluene (BHA and BHT) are repulsive to ants in higher concentration levels in the ant bait.

A small concentration level of BHA/BHT is formulated in an ant bait that showed little or no repulsion to ants. It also extended the shelf life of the package ant bait for over 1.5-2 years (accelerated aging studies) and prevented rancidity when applied in the field for over a period of 2-3 months.

Fungicide and Bactericide

A fungicide/bactericide, such as 1,2-benzisothiazolin-3-one, in trace amounts has been added to ant baits to prevent spoilage due to fungal and bacterial spoilage. Little or no loss in attractant activity was observed in the ant bait.

Fragrance

Some ant baits have a slightly strong odor from due to the active toxicant, or attractant, or a combination of both. In order to mask this slight odor that may be repulsive to ants or to humans handling the bait, a fragrance is added.

Surfactant (Odor Masking)

If the odor of the active insecticide is offensive or malodorous, the active insecticide is impregnated in a water or oil soluble surfactant. This surfactant not only masks the odor of the active insecticide but also serves as a time delay mechanism for allowing the ant a longer period of time to bring the bait to the nest without killing the ant ‘instantaneously’.

Dye

A bright colored dye, in low concentration, should be used to color the ant bait. This highly colored ant bait will be easily visible during application in the field for greater efficiency during broadcasting. The bright color will also serve as a warning that it is not to be used as a food source for humans and animal feed. At the same time the bait must not be attractive to birds or bees.

Physical Characteristics

Vapor pressure of the bait components is very important in the design of an attractive ant bait. The bait must be able to release its attractive vapor components at such a rate that it does not rapidly loose its attractiveness. At the same time there must be sufficient volatility for the ant to locate the bait. Also the baits must not quickly “dry out” and become hard and difficult for the ant to use. Here the proper use of softening and formulating aids is important in giving the right texture and feel to the bait. Many of the bait components readily decompose and require the addition of preservatives in order to maintain the effectiveness of the bait. Many necessary components and preservatives are not attractive to ants and even in some cases are repulsive to them.

### DETAILED DESCRIPTION OF THE INVENTION

The following details the conditions of the invention with examples of various uses giving examples of the procedures and results of tests.

Bait Characteristics:

The following are examples of the current invention and the various active ant baits and their composition and testing use.

Active Toxicant:

The following are organophosphates that can be used as toxicants in ant baits at the proper low use level: acephate, azinphos-methyl, chlorpyrifos, diazinone, malathione, phosmet, prothiophos, pyrimiphos-methyl, and many others. Also the synthetic pyrethroids may be used as toxicants in ant baits at the proper low use level: cyfluthrin, deltamethrin, permethrin, and esphenvalerate. Other toxicants would include: methomyl, carbaryl, and imidacloprid, and the like. Acephate is the most preferred toxicant.

Surfactant:

The most effective surfactants are solid ethoxylated alcohol and alkoxylated alkyl diamino nonionic surfactants such as the Pluronic and Tetronic surfactants. Solid water or oil soluble surfactants are equally effective for impregnating the active toxicant.

Attractant:

The most effective attractants are the following:

Sweeteners such as sugar (sucrose, fructose, etc), bee honey, fruit nectars, syrups and others.

Natural oils such as oils from animal (bacon fat etc), fish (cod liver and others), vegetable oils (soybean, peanut, sesame, corn, palm, safflower, olive, and others).

Protein (animal and vegetable protein, dried fish and shrimp protein and protein in commercial dog and cat foods).

Chitin (shrimp, crab, lobster and other crustacean shells) that are ground up to a small particulate size.

Milk (milk; evaporated, condensed and powdered milk products).

Combinations of all of the above types of attractants (sugar, oil, protein, chitin and milk) in an ant bait provides a general or universal ant bait that is attractive to practically all species of ants.

Carrier:

The following are the most effective carriers for ant baits:

Solid support such as dry bread crumbs, cereal, corn meal, corn grits and others for solid ant baits.

Absorbent material such as sponge, cotton balls, cotton swabs, absorbent paper tissue and others for liquid ant baits.

Gels and jelly ant baits containing the attractant and active toxicant. Hydrophilic polyhydroxyl polymers and co-polymers such as xanthan gums of various types (such as Kelzan®) are examples of gel forming substances.

Antioxidants:

Butylated hydroxy anisole (BHA) and/or butylated hydroxy toluene, tertiary butylhydroquinone and others (see The Florida Entomologist, Vol 17, No. 3, 1974) are the most effective antioxidants in ant baits.

Fungicide and bactericide:

1,2-benzisothiazolin-3-one (Proxel®, trace amount, 0.02-0.06%) provides the needed fungicide/bactericide for effective ant baits.

Fragrance:

Rose, strawberry, lemon or other fragrances (small amount 0.5-0.8%) provide the right odor for bait control of ants.

Surfactant (Odor Masking):

Solid water or oil soluble ethoxylated alcohols (BASF Pluronic® and Tetronic®, 10-50%) act as surfactants and mask many objectionable odors.

Dye:

Calco Oil Red N-1700® (0.05-0.07%) is an example of the type of effective dye used

Physical Characteristics:

Solid ant bait screened or sieved to optimum particle size for particular ant species.

Anti-agglomeration materials (0.2-1.0) %; amorphous diatomaceous, silica or clays) is added to prevent agglomeration of the ant bait.

### EXAMPLES OF THE INVENTION

The following list of ant bait formulas list examples of liquid, solid and gels for various species of ants or ant groups:

### Example 1

Liquid Ant Bait for Sugar Loving Ants - General House and Garden Ants/
(Argentine, Pharaoh, Harvester and Other Ants)

| Ingredients, Wt. % | 1a | 1b | 1c | 1d |
|---|---|---|---|---|
| Acephate, 99.5% | 1.0 (0.6-1.4) | 1.0 (0.6-1.4) | 1.0 (0.6-1.4) | 1.0 (0.6-1.4) |
| Sugar (White or Granular | 20 | 15 | 15 | 15 |
| Hawaiian) | | | | |
| Honey (Bee honey) | — | 5 | 5 | 5 |
| Proxel ® | — | 0.02 | 0.02 | 0.02 |
| Fragrance (Rose) | — | — | 0.5 | 0.5 |
| Dye (Calco Oil Red N-1700) | — | — | — | 0.05 |
| Water (Deionized) | 79.0 | 78.98 | 78.48 | 78.43 |
| TOTAL: | 100.0 | 100.0 | 100.0 | 100.0 |

1a - Technical Acephate, followed by sugar and honey are dissolved in water using a Blender or a mechanical/electric motor equipped with a stirrer blade.
1b - Same as 1a, except Proxel ® preservative is added.
1c - Same as 1b, except Fragrance (Rose) is added.
1d - Same as 1c, except Red Dye is added.

The above formulations should be stored in a cool area or refrigerator, away from heat and light.

### Example 2

Granular Solid Ant Bait for Sugar Loving Ants - General House
and Garden Ants (Argentine, Pharaoh, Harvester and Other Ants)

| Ingredients, | | | | |
|---|---|---|---|---|
| Wt. % | 2a | 2b | 2c | 2d |
| Acephate, | 1.0 (0.6-1.4) | 1.0 (0.6-1.4) | 1.0 (0.6-1.4) | 1.0 (0.6-1.4) |
| 99.5% | | | | |
| Peanut Butter | 5.0 | 5.0 | 5.0 | 5.0 |
| (Skippy, | | | | |
| Creamy) | | | | |
| Sugar (White | 4.0 | 4.0 | 4.0 | 4.0 |
| or Raw | | | | |
| Hawaiian) | | | | |
| Honey (Bee | 1.0 | 1.0 | 1.0 | 1.0 |
| Honey) | | | | |
| Dry Bread | 89.0 | 88.98 | 88.43 | 88.38 |
| Crumbs | | | | |
| Proxel ® | — | 0.02 | 0.02 | 0.02 |
| Fragrance | — | — | 0.5 | 0.5 |
| (Rose) | | | | |
| Tenox 4 ® | — | — | 0.05 | 0.05 |
| Calco Oil Red | — | — | — | 0.05 |
| N-1700 | | | | |
| TOTAL: | 100.0 | 100.0 | 100.0 | 100.0 |

2a - Technical Acephate, sugar, honey and Peanut Butter are ground up to form an intimate mix. Dry bread crumbs are added and thoroughly mixed to form a semi-dry, granular solid. This solid is ground up in a blender and sieved through a small stainless wire screen to give a fine solid.
2b - Proxel ® preservative is added to 2a when Acephate, sugar, honey and Peanut Butter are ground up and mixed.
2c - Fragrance and Tenox 4 ® are added to the Proxel ® in 2b.
2d - Calco Oil Red N-1700 added to the Fragrance, Tenox 4 ® and Proxel ® in 2c. If the solid ant baits (2a-2d) tend to agglomerate, an amorphous Diatomaceous Earth (0.2-0.6%) is added to prevent agglomeration.

Store the above solid ant baits in a cool dry location, away from heat.

### Example 3

Gel Ant Baits for Sugar Loving Ants - General House and Garden Ants
(Argentine, Pharaoh, Harvester and Other Ants)

| | 3a | 3b | 3c | 3d |
|---|---|---|---|---|
| | 10% Kelzanc ® | 20% Kelzan ® | 30% Kelzan ® | 40% |
| Ingredients, Wt. % | Gel | Gel | Gel | Kelzan ® Gel |
| Kelzan ® Powder | 9 | 18 | 27 | 36 |
| Water, Deionized | 82.38 | 73.38 | 64.38 | 55.38 |
| Acephate, 99.5% | 1.0 | 1.0 | 1.0 | 1.0 |
| Sugar | 4.0 | 4.0 | 4.0 | 4.0 |
| Honey | 3.0 | 3.0 | 3.0 | 3.0 |
| Proxel ® | 0.02 | 0.02 | 0.02 | 0.02 |
| Fragrance | 0.5 | 0.5 | 0.5 | 0.5 |
| Tenox 4 ® | 0.05 | 0.05 | 0.05 | 0.05 |
| Dye | 0.05 | 0.05 | 0.05 | 0.05 |
| (Calco Oil Red N- | | | | |
| 1700) | | | | |
| TOTAL: | 100.0 | 100.0 | 100.0 | 100.0 |

The above gel ant baits is made in a low to a higher consistency gel. Any one of the above gel ant baits can be formulated by first dissolving Acephate, sugar, honey, Proxel®, fragrance, Tenox 4® and dye in water. This mixture is next added to the Kelzan® powder and stirred until a gel of uniform consistency is formed.

The ant bait gel can be cut up or extruded into smaller pieces. These gel ant baits should be packaged in a sealed container and stored in a cool environment.

### Example 4

Granular Solid Ant Baits for Milk, Protein, Oil and Chitin Loving Ants

| Ingredients, Wt. % | Milk | Protein | Oil | Chitin |
|---|---|---|---|---|
| Acephate, 99.5% | 1.0 | 1.0 | 1.0 | 1.0 |
| Powdered Milk | 5.0 | — | — | — |
| Condensed Milk | 5.0 | — | — | — |
| Dog Food or Cat Food | — | 10.0 | — | — |
| Soybean Oil | — | — | 5.0 | — |
| Sesame Oil | — | — | 5.0 | — |
| Dried Shrimp Shells | — | — | — | 10.0 |
| Tenox 4 ® | 0.05 | 0.05 | 0.05 | 0.05 |
| Fragrance | 0.5 | 0.5 | 0.5 | 0.5 |
| Dye (Calco Oil Red N-1700) | 0.05 | 0.05 | 0.05 | 0.05 |
| Dry Bread Crumbs | 88.4 | 88.4 | 88.4 | 88.4 |
| TOTAL: | 100.0 | 100.0 | 100.0 | 100.0 |

The above ant baits are formulated by premixing all the respective ingredients for each ant bait and adding each premix to dry bread crumbs. The final mixture is again thoroughly mixed, ground up and sieved.

### Example 5

Granular Solid Ant Bait - Acephate Toxicant Impregnated in
A Solid Water Soluble Surfactant

| Ingredients, Wt. % | % |
|---|---|
| Acephate, 99.5%/BASF Tetronic | 2.0 |
| Surfactant (50:50 Mixture) | |
| Sugar | 10 |
| Honey | 5 |
| Tenox 4 ® | 0.05 |
| Proxel ® | 0.02 |
| Dye (Calco Oil Red N-1700) | 0.05 |
| Dry Bread Crumbs | 82.88 |
| TOTAL: | 100.00 |

Acephate is impregnated in Tetronic surfactant (BASF, alky alcohol ethoxylate) by mixing and milling the mixture of both products in a Hammer Mill. Acephate and Tetronic surfactant can also be intimately mixed by dissolving equal quantities of both compounds in water and removing the water by rotary evaporation under vacuum on a hot water bath.

The above solid ant bait is formulated as described in the prior examples.

### Example 6

Solid Granular Ant Bait Requiring Higher Insectide Level for
Killing Large Resistant Red Tree Ants

| Ingredients, Wt % | 6a | 6b |
|---|---|---|
| Acephate, 99.5% | 1.0 | 1.5 |
| Sugar (Raw Hawaiian) | 5 | 5 |
| Honey | 10 | 10 |
| Powdered Milk | 10 | 10 |
| Condensed Milk | 5 | 5 |
| Dried Shrimp (ground up) | 10 | 10 |
| Dried Fish (ground up) | 10 | 10 |
| Dried Bread Crumbs | 47.98 | 48.48 |
| Proxel ® | 0.02 | 0.02 |
| Tenox 4 ® | 0.05 | 0.05 |
| TOTAL: | 100.0 | 100.0 |

The solid ant bait is formulated, ground up and sieved as described in the prior examples. 6a gave high acceptance but lower red tree ant kill. 6B gave high acceptance and kill.

### Example 7

Liquid Carpenter Ant Baits

| Ingredients, Wt. % | 7a | 7b |
|---|---|---|
| Acephate, 99.5 | 1.2 | 0.2 |
| Sugar (Raw Hawaiian | 20 | 20 |
| Sugar) | | |
| Honey (Bee Honey) | 30 | 30 |
| Proxel ® | 0.02 | 0.02 |
| Water | 48.78 | 49.78 |
| TOTAL: | 100.0 | 100.0 |

The above liquid carpenter ant bait was not formulated with a fragrance or dye, although both these additives may can be added. Soak the liquid ant bait in an absorbent wick, cotton ball or tissue and place on ant trail.

A carpenter ant ingested bait 7a for approximately 20 minutes, walked approximately 1.5-2 feet and was killed. Another carpenter ant ingested bait 7b for approximately 20 minutes, walked 20-30 feet, disappearing in the brush. All the carpenter ants in the nest were killed after 12-14 hours.

### Example 8

Solid Granular, Creamy Solid Paste and Gel Baits for
Red Imported Fireant (RIFA)

| Ingredient, Wt. % | 8a. Granular Solid | 8b. Creamy Solid | 8c. Gel |
|---|---|---|---|
| Acephate, 99.5% | 0.8 | 0.8 | 0.8 |
| Sugar (Raw Hawaiian) | 10 | 10 | 10 |
| Honey (Bee Honey) | 5 | 5 | 5 |
| Peanut Butter | — | 73.2 | — |
| Soybean Oil | 10 | 5 | 5 |
| Sesame Oil | 10 | 5 | 5 |
| Water, Deionized | 1 | 1 | 54.2 |
| Dry Bread Crumbs | 63.2 | — | — |
| Kelzan ® Powder | — | — | 20 |
| TOTAL: | 100.0 | 100.0 | 100.0 |

The solid and creamy solid RIFA baits are formulated as described in the prior examples. The gel RIFA bait is prepared by first mixing Kelzan® with the one half of the water required in the formula. The mixture of sugar, honey, soybean oil and sesame oil is mixed with the remaining half of the water and added to the prepared Kelzan® gel.

### Ant Testing of Various Baits Described in the Examples

The ant baits of the above examples were tested in their natural environment where the particular ants were found. The baits were distributed in small amounts in the areas where the ants were seen to be active. All of the baits were readily accepted by the various ants. Gradually in all of the examples the numbers of ants in the treated areas was reduced to the point that none could be found.

| Example Number | Percentage Ants Killed |
|---|---|
| 1 a, b, c, d | 100% (Little or no live ants observed after 12-14 hours) |
| 2 a, b, c, d | 100% (Little or no live ants observed after 12-14 hours) |
| 3 b (a, c, d not tested) | 100% (Little or no live ants observed after 12-14 hours) |
| 4 a, b, c, d | 100% (Little or no live ants observed after 12-14 hours) |
| 5 | 100% (Little or no live ants observed after 12-14 hours) |
| 6 a | High acceptance (60-70% kill of large red ants after 12-14 hours). |
| | Nest of 3-4 sewn leaves not destroyed. |
| 6 b | High acceptance with approximately 95% large red tree ants killed |
| | after 12-14 hours, remaining 5% were sluggish or slow moving. All |
| | ant nests on the trees, consisting of 3-4 sewn leaves, appeared broken |
| | apart or destroyed. |
| 7 a | A single carpenter ant ingesting bait 7a died after walking 1.5-2 feet, |
| | indicating the level of acephate (1.2%) in the bait was too high. |
| 7 b | Another carpenter ant ingesting bait 7b walked 20-30 feet and |
| | disappeared into the brush, indicating the level of acephate was |
| | sufficient for the ant to carry back to the nest. 100% kill resulted, with |
| | little or no ants observed after 12-14 hours) |
| 8 a, b, c | 100% (Little or no ants observed after 12-14 hours) |

The above descriptions and examples should not be taken as such to limit my claims. Although the invention has been described with reference to preferred embodiments and examples thereof, the scope of the present invention is not limited only to those described embodiments. As will be apparent to persons skilled in the art, modifications and adaptations to the above-described invention can be made without departing from the spirit and scope of the invention, which is defined and circumscribed by the appended claims.

1. A method of destroying ants and their colonies by the use of a bait attractant to ants and also carried by them back to their individual colony to destroy the remainder of the colony.

2. The method of claim 1 wherein said bait is effective on multiple species of ants.

3. A method of claim 2 wherein said bait is effective on fire ant species.

4. A method of claim 2 wherein said bait is effective on carpenter ants.

5. A method of claim 1 wherein said bait is composed of a toxicant in such concentration and kind to not kill ants ingesting the bait until after they have returned to their individual colony.

6. A method of claim 1 wherein the said bait is composed of a toxicant in such concentration to not kill ants ingesting the bait until after they have returned to their individual colony and the toxicant is acephate.

7. A method of claim 1 wherein the said bait is composed of an acceptable toxicant plus an attractant composed of at least one of the following types: sweeteners, natural oils, proteins, chitin, or milk products.

8. A method of claim 8 wherein the said toxicant is acephate at a concentration such that the ants ingesting the bait are not killed until after they return to their colony.

9. A method of claim 1 wherein the said bait is composed of an acceptable toxicant plus a carrier such as a dry support, absorbent material or gel type product attractive to ants.

10. A method of claim 8 wherein said bait is composed of an acceptable toxicant plus an attractant containing an acceptable amount of preservative or antioxidant to extend the shelf life of the bait and yet at a concentration for the bait to remain attractive to ants.

11. A granular bait for killing ants in their nests comprising by weight, 0.1 to 3% toxicant, 10 to 30% of combination of attractants, 10 to 80% of a carrier, 5 to 10% of a combination of antioxidant, preservative, color, surfactant and fragrance such that the bait is taken back to the colony and is effective between 12 to 14 hours.

12. The granular bait of claim 12 wherein the toxicant is acephate.

13. The gel bait of claim 12 with the addition of a gel agent and water.

14. The gel bait of claim 14 wherein the toxicant is acephate.

15. The liquid bait of claim 12 comprising the addition of 60 to 80% water.

16. The liquid bait of claim 16 wherein the toxicant is acephate.

17. An ant bait composition having delayed toxic action to ants comprising an ant attractant bait, a toxic amount of an ant toxicant, a suitable carrier with adjutants, and a delayed action formulation free of ant repellency characteristics.

18. The ant bait composition of claim 18 wherein said toxicant and said formulation provides delayed toxicity allowing the ants to return to the colony.

19. The ant bait composition of claim 18 wherein said toxicant comprises at least one insecticide selected from the group consisting of chlorpyrophos, acephate, avermectin, azinphos-methyl, diazinone, malathione, phosmet, prothiophos, pyrimiphos-methyl, synthetic pyrethroids cyfluthrin, deltamethrin, permethrin, esphenvalerate, methomyl, carbaryl, and imidacloprid,

20. The ant bait composition of claim 18 wherein said ant attractant bait is selected from the group consisting of sweeteners, natural oils, proteins, chitin and milk products.

21. A method of controlling ants, which method consisting essentially of application of an ant bait composition having delayed ant toxic action comprising an ant attractant bait, containing a toxic effective amount of an ant effective toxicant, and in a delayed action formulation free of ant repellency characteristics.
